(19) United States
(12) Patent Application Publication
(10) Pub. No.: US 2006/0097984 A1
(43) Pub. Date: May 11, 2006

(54) Key sensor in mobile station

(75) Inventor: Dong Bong Kim, Seoul (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/250,991

(22) Filed: Oct. 13, 2005

(30) Foreign Application Priority Data
Oct. 13, 2004 (KR) 10-2004-0081822

(51) Int. Cl. G09G 5/00

(52) U.S. Cl. 345/156

(57) ABSTRACT

A key sensing apparatus in a mobile station comprises a keypad comprising a plurality of keys, and a key interrupt block operatively coupled to the keypad, adapted to receive a key interrupt value from the keypad. The key sensing apparatus also comprises a key bit detection unit operatively coupled to the keypad, adapted to receive a voltage value from the keypad. The key sensing apparatus also comprises a processing unit operatively coupled to the key interrupt block and the key bit detection unit, adapted to sense the voltage value in response to receipt of the key interrupt value by the key interrupt block. The key sensing apparatus may further compare the voltage value against stored key value in a key value table to identify a depressed key. The voltage value may be a binary value having a set bit length.

### CROSS-REFERENCE TO RELATED APPLICATIONS

Pursuant to 35 U.S.C. § 119(a), this application claims the benefit of earlier filing date and right of priority to Korean Application No. 2004-0081822, filed on Oct. 13, 2004, the contents of which are hereby incorporated by reference herein in their entirety.

### FIELD OF THE INVENTION

The present invention relates generally to a mobile station and, more particularly, to key sensing in a mobile station.

### BACKGROUND OF THE INVENTION

A mobile station (e.g., mobile phone) uses a key matrix. FIG. 1 is a circuit diagram illustrating a key matrix system, according to a related art. FIG. 2 is a diagram illustrating an operation of a key in the key matrix system, according to a related art.

Referring to FIGS. 1 and 2, many general purpose input/output (GPIO) pins are required to perform mobile station functions, but, since GPIO pins are allocated in a limited number to a chipset of the mobile station, a shortage of GPIO pins available for new functions may result.

Referring to FIG. 1, key sensing is recognized by a simple key combination according to the key matrix system. Therefore, many GPIO pins are required. In the embodiment depicted in FIG. 1, eleven GPIO pins (KYPD [1, [3], [5], [7], [9], [11], [13], [15], [17], [19], ON_SW) are used in implementing twenty-five keys (END/PWA, PF1, OK, PF2, SND, M, [], CLR, UP, DOWN, LEFT, RIGHT, 1, 2, 3, 4, 5, 6, 7, 8, 9, 0, *, #, . . . ).

Referring to FIG. 2, principles of key operation are described. When ‘Keysense_int’ is sensed, a central processing unit (CPU) checks KYPD[1], [3], [5], [7] and [9] among the GPIO pins via ‘KEYSENSE_READ’ lines. Key scan lines KYPD[11],[13],[15],[17] and [19] are sequentially pulled down to ‘low’ one by one. Such operation corresponds to one scanning process. A key pressed when ‘Keysense_int’ is pulled down to ‘low’ is sensed accordingly.

In the related art approach, dedicated keys (e.g., a dedicated camera key, etc.) for performing new functions must be allocated to number keys, character keys, and/or direction keys. However, since the number of GPIO pins that may be allocated to the chipset of the mobile station is limited, there may be a shortage of GPIO pins for new mobile station functions.

### SUMMARY OF THE INVENTION

Accordingly, the present invention is directed to key sensing in a mobile station that substantially obviates one or more problems due to limitations and disadvantages of the related art.

An object of the present invention is to provide key sensing using an applied key matrix.

Another object of the present invention is to provide key sensing by which allocation of general purpose input/output (GPIO) pins may be reduced to enable a mobile station to perform more functions.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, a key sensing apparatus in a mobile station comprises a keypad comprising a plurality of keys, and a key interrupt block operatively coupled to the keypad, adapted to receive a key interrupt value from the keypad. The key sensing apparatus also comprises a key bit detection unit operatively coupled to the keypad, adapted to receive a voltage value from the keypad. The key sensing apparatus also comprises a processing unit operatively coupled to the key interrupt block and the key bit detection unit, adapted to sense the voltage value in response to receipt of the key interrupt value by the key interrupt block.

The key sensing apparatus may further comprise a key value table adapted to store key values, wherein the processing unit is adapted to compare the voltage value against stored key values in the key value table to identify a depressed key of the plurality of keys in the keypad. The voltage value may be a binary value having a set bit length.

A key of the plurality of keys in the keypad may comprise an external electrode adapted to optionally provide an electrical ground. The key may also comprise a plurality of line electrodes disposed interior to the external electrode, optionally electrically disconnected from the external electrode. The key may also comprise a dome sheet disposed in proximity to the external electrode and the plurality of line electrodes, adapted to provide an electrical connection between the external electrode and the plurality of line electrodes in response to depression of the key.

The key sensing apparatus may further comprise a key interrupt line operatively coupled to a first line electrode of the plurality of line electrodes, adapted to output the voltage value corresponding to the key interrupt value in response to the depression of the key. The key sensing apparatus may further comprise a plurality of bit lines, each respectively coupled to a different line electrode of the plurality of line electrodes aside from the first line electrode, adapted to perform bit operations. The key sensing apparatus may further comprise a first voltage-impression pull-up resistor adapted to provide a resistance corresponding to the key interrupt value, and a plurality of second voltage-impression pull-up resistors adapted to provide resistances corresponding to the voltage value. The first voltage-impression pull-up resistor may be connected in parallel to the key interrupt line. The plurality of second voltage-impression pull-up resistors may be connected in parallel to a corresponding bit line of the plurality of bit lines. The key bit detection unit may receive the voltage value from the plurality of second voltage-impression pull-up resistors in response to the depression of the key.

In another embodiment, a key adapted for use in a mobile station comprises an external electrode adapted to optionally provide an electrical ground, and a plurality of line electrodes disposed interior to the external electrode, optionally electrically disconnected from the external electrode. The key also comprises a dome sheet disposed in proximity to the external electrode and the plurality of line electrodes, adapted to provide an electrical connection between the external electrode and the plurality of line electrodes in response to depression of the key.

In yet another embodiment, a method for key sensing in a mobile station having a keypad comprising a plurality of keys comprises receiving a key interrupt value from the keypad in response to depression of a key, and receiving a voltage value from the keypad in response to output of the key interrupt value by the keypad. The method also comprises comparing the voltage value against stored key values, and identifying a depressed key based on the comparing of the voltage value against the stored key values. The voltage value may be a binary value having a set bit length. The stored key values may be stored in a key value table.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a circuit diagram illustrating a key matrix system, according to a related art.

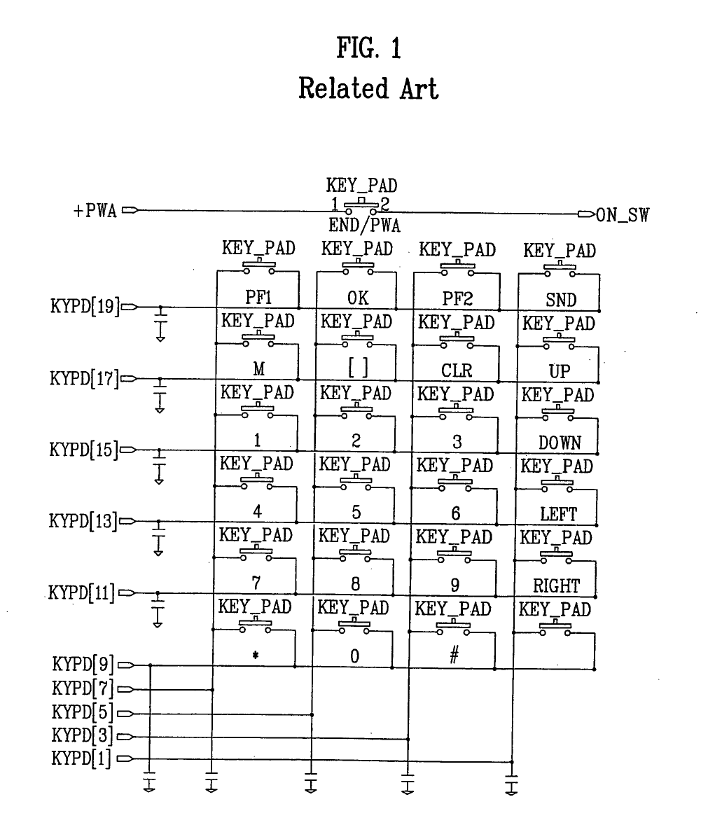

FIG. 2 is a diagram illustrating an operation of a key in the key matrix system, according to a related art.

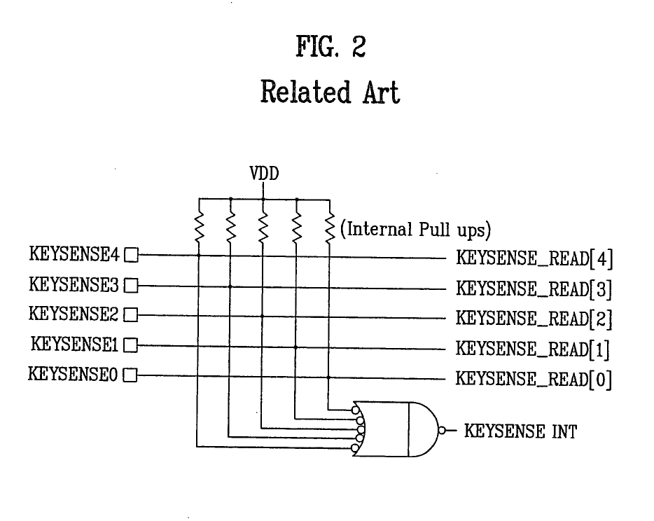

FIG. 3 is a diagram illustrating a key, according to an embodiment of the present invention.

FIG. 4 is a block diagram illustrating a decoder block for key sensing, according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

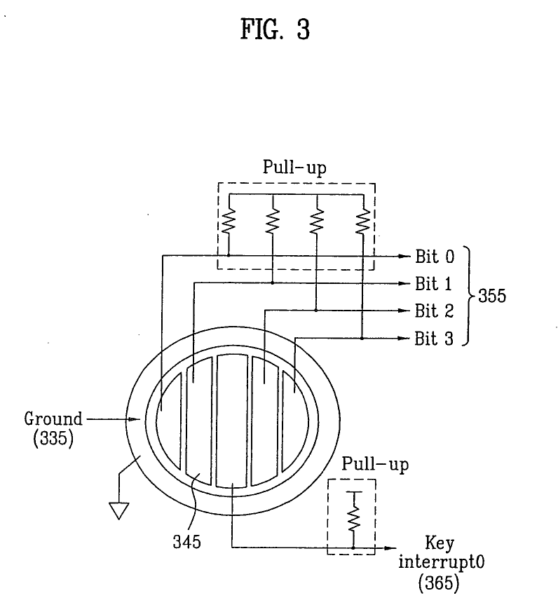

FIG. 3 is a diagram illustrating a key 315, according to an embodiment of the present invention.

Referring to FIG. 3, the key may be included in a keypad and, in turn, an apparatus for key sensing. The key includes an external electrode 335 that may act as a ground, mutually disconnected line electrodes 345 within the external electrode, bit lines 355 respectively connected to the line electrodes, and a key interrupt line 365.

FIG. 3 shows an exemplary key having four bit lines; Bit0, Bit1, Bit2 and Bit3, and one key interrupt line, key interrupts. The key 315 uses the bit lines Bit0, Bit1, Bit2 and Bit3 for bit operations. The key 315 provides each of the bit lines with an internal pull-up resistor for voltage impression. Furthermore, the key interrupt line is provided with an internal pull-up resistor for voltage impression of a prescribed key interrupt. In such case, one internal pull-up resistor of voltage impression may be connected in parallel to the corresponding bit line. Additionally, the internal pull-up resistor for the voltage impression of the key interrupt may be connected in parallel to the corresponding key interrupt line. Although the present invention is described with using internal pull-up resistors, external pull-up resistors may also be used.

One of the line electrodes 345 may be connected to the key interrupt line 365, while the remaining line electrodes 345 are connected to the bit lines 355 by a one-to-one correspondence.

The key 315 may further include a dome sheet. The dome sheet provides contact between the external electrode 335 and the line electrodes 345 when a key is pressed. That is, when a key is pressed, the dome sheet is pressed, and the pressed dome sheet brings the external electrode into contact with the line electrodes.

Thus, a load is placed on the voltage-impression internal pull-up resistor of the key interrupt such that a voltage corresponding to a value of the corresponding key interrupt (e.g., key interrupt0) is outputted. Furthermore, a load is placed on each of the voltage-impression internal pull-up resistors, and a voltage value (e.g., a binary voltage value having a prescribed bit length) is outputted. To this end, one of the line electrodes 345 is connected to the key interrupt line 365 and the remaining line electrodes 365 are respectively connected to the bit lines 355 by a one-to-one correspondence. Binary voltage values having 4-bit length each, for example, may be outputted by the voltage-impression internal pull-up resistors. In such case, sixteen different key values may be generated.

A procedure for generating sixteen different key values is further described below. If the dome sheet is not initially pressed, a voltage value of the key interrupt pin Key interrupts is ‘high’ and a value of each of the bit lines Bit0, Bit1, Bit2 and Bit3 is ‘high’. However, if the dome sheet is pressed, i.e., if the key is pressed, the line electrode connected to the key interrupt line 365 and the remaining (e.g., four) line electrodes connected one-to-one to the bit lines, respectively, are brought into contact with the external electrode 335. A voltage value of the key interrupt line Key interrupt0 is accordingly dropped to ‘low’.

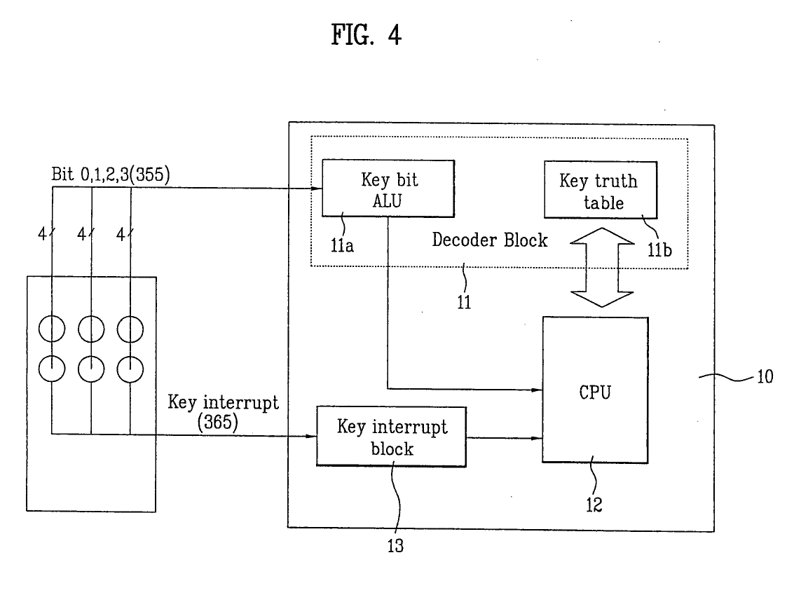

FIG. 4 is a block diagram illustrating a decoder block for key sensing, according to an embodiment of the present invention.

Referring to FIG. 4, a processing unit, such as CPU 12, recognizes that the key 315 (e.g., dome sheet) is pressed and checks a per line voltage value inputted from each of the bit lines Bit0, Bit1, Bit2 and Bit3. A binary value having a 4-bit length is obtained from a combination of the voltage values inputted from the bit lines Bit0, Bit1, Bit2 and Bit3, respectively.

The below Table 1 shows a preferred key value table. Referring to Table 1, when the line electrodes connected to the bit lines Bit0, Bit1, Bit2 and Bit3, respectively, are brought into contact with the external electrode as a ground electrode, different binary values having a 4-bit length each may be generated from the voltage values outputted via the bit lines. Such operation may be performed by configuring different values of the internal pull-up resistors connected in parallel to the bit lines.

For example, when the dome sheet is pressed, if the voltage value placed on the internal pull-up resistor of the first bit line Bit0 is ‘low’ and if the voltage value of each of the internal pull-up resistors of the second to fourth bit lines Bit1 to bit 3 is ‘high’, the combination of the output voltage values of the bit lines becomes ‘low, high, high and high’ to correspond to a binary value ‘1, 0, 0, 0,’.

Hence, the CPU 12 depicted in FIG. 4 recognizes one binary value from the per line voltage value inputted from the bit lines Bit0 to Bit 3 and then searches the key value table in Table 1 for a key value corresponding to the recognized binary value. Thus, the CPU 12 determines a current value of the pressed key with reference to the key value table shown in the below Table 1.

TABLE 1

| Bit0 | Bit1 | Bit2 | Bit3 | Key interrupt0 | Key | Bit0 | Bit1 | Bit2 | Bit3 | Key interrupt1 | Key |
|---|---|---|---|---|---|---|---|---|---|---|---|
| 1 | 1 | 1 | 1 | 1 | No Key Detection | 1 | 1 | 1 | 1 | 1 | No Key Detection |
| 0 | 0 | 0 | 0 | 0 | 0 | 0 | 0 | 0 | 0 | 0 | 16 |
| 0 | 0 | 0 | 1 | 0 | 1 | 0 | 0 | 0 | 1 | 0 | 17 |
| 0 | 0 | 1 | 0 | 0 | 2 | 0 | 0 | 1 | 0 | 0 | 18 |
| 0 | 0 | 1 | 1 | 0 | 3 | 0 | 0 | 1 | 1 | 0 | 19 |
| 0 | 1 | 0 | 0 | 0 | 4 | 0 | 1 | 0 | 0 | 0 | 20 |
| 0 | 1 | 0 | 1 | 0 | 5 | 0 | 1 | 0 | 1 | 0 | 21 |
| 0 | 1 | 1 | 0 | 0 | 6 | 0 | 1 | 1 | 0 | 0 | 22 |
| 0 | 1 | 1 | 1 | 0 | 7 | 0 | 1 | 1 | 1 | 0 | 23 |
| 1 | 0 | 0 | 0 | 0 | 8 | 1 | 0 | 0 | 0 | 0 | 24 |
| 1 | 0 | 0 | 1 | 0 | 9 | 1 | 0 | 0 | 1 | 0 | 25 |
| 1 | 0 | 1 | 0 | 0 | 10 | 1 | 0 | 1 | 0 | 0 | 26 |
| 1 | 0 | 1 | 1 | 0 | 11 | 1 | 0 | 1 | 1 | 0 | 27 |
| 1 | 1 | 0 | 0 | 0 | 12 | 1 | 1 | 0 | 0 | 0 | 28 |
| 1 | 1 | 0 | 1 | 0 | 13 | 1 | 1 | 0 | 1 | 0 | 29 |
| 1 | 1 | 1 | 0 | 0 | 14 | 1 | 1 | 1 | 0 | 0 | 30 |
| 1 | 1 | 1 | 1 | 0 | 15 | 1 | 1 | 1 | 1 | 0 | 31 |

The key values stored in the key value table (e.g., Table 1) are determined by the resistances of the internal pull-up resistors provided to the four bit lines of the key, respectively. In particular, the key values, as shown in Table 1, correspond to 4-bit binary values, respectively. Sequentially, the voltage value put on the internal pull-up resistor of the first bit line Bit0 indicates a most significant bit of the 4-bit binary value, the voltage value put on the internal pull-up resistor of the second bit line Bit1 indicates a second bit, the voltage value put on the internal pull-up resistor of the third bit line Bit2 indicates a third bit, and the voltage value put on the internal pull-up resistor of the fourth bit line Bit3 indicates a least significant bit. Therefore, the 4-bit binary value may represent sixteen key values. The CPU 12 may accordingly determine one of the sixteen key values by referencing the key value table. Furthermore, a decoder block 11 shown in FIG. 4 enables a bit operation to identify and sense the key values corresponding to the values of the key value table (e.g., Table 1).

The key sensing apparatus may include the key shown in FIG. 3, a key interrupt block 13 for obtaining a voltage value corresponding to a key interrupt value from the key to provide to a CPU 12, a key bit detection unit, such as key bit ALU (arithmetic and logic unit) 11a, for obtaining voltage values from bit lines of the key, and a key value table 11b for storing key values (e.g., 4-bit binary values) corresponding to the voltage values of the bit lines of the key. The key sensing apparatus may further include the CPU 12 for recognizing the key values.

When sensing the key interrupt value provided from the key interrupt block 13, the CPU 12 recognizes the pressed key by interoperating with the decoder block 11. To this end, the CPU 12 may be provided with the voltage values of the bit lines of the key from the key bit ALU 11a. The CPU 12 then searches the key value table 11b for the corresponding key value using the provided voltage values. Thus, the CPU 12 may then recognize the current value of the pressed key.

In brief, the CPU 12 may recognize the pressed key as described below. When obtaining the key interrupt value from the key, the CPU 12 may read the voltage values placed on the internal pull-up resistors provided to the bit lines, respectively. Such operation may be performed using the key bit ALU 11a. The CPU 12 then compares the binary value having a prescribed bit length that is determined using the read voltage values against a plurality of the previously stored key values by referencing the key value table. The CPU 12 then identifies the key value corresponding to the binary value using the comparison result. For example, if the value (e.g., voltage level) of the key interrupt Key interrupt0 drops from ‘high’ to ‘low’ (high→low) and if the voltage values of the bit lines Bit0 to Bit3 correspond to ‘1, 1, 0, 0’, the CPU 12 may recognize the key ‘12’ corresponding to ‘1100’ in the key value table.

The key sensing of the present invention may also be used in conjunction with other numbers of key values, such as 25 or 32, that are generated by outputting voltage values corresponding to a binary value having at least 5-bit length by internal pull-up resistors for voltage impression. Such a configuration may be implemented by, for example, adjusting the number of bit lines, internal pull-up resistors, and line electrodes.

In one embodiment, a key sensing apparatus in a mobile station comprises a keypad comprising a plurality of keys, and a key interrupt block operatively coupled to the keypad, adapted to receive a key interrupt value from the keypad. The key sensing apparatus also comprises a key bit detection unit operatively coupled to the keypad, adapted to receive a voltage value from the keypad. The key sensing apparatus also comprises a processing unit operatively coupled to the key interrupt block and the key bit detection unit, adapted to sense the voltage value in response to receipt of the key interrupt value by the key interrupt block.

The key sensing apparatus may further comprise a key value table adapted to store key values, wherein the processing unit is adapted to compare the voltage value against stored key values in the key value table to identify a depressed key of the plurality of keys in the keypad. The voltage value may be a binary value having a set bit length.

A key of the plurality of keys in the keypad may comprise an external electrode adapted to optionally provide an electrical ground. The key may also comprise a plurality of line electrodes disposed interior to the external electrode, optionally electrically disconnected from the external electrode. The key may also comprise a dome sheet disposed in proximity to the external electrode and the plurality of line electrodes, adapted to provide an electrical connection between the external electrode and the plurality of line electrodes in response to depression of the key.

The key sensing apparatus may further comprise a key interrupt line operatively coupled to a first line electrode of the plurality of line electrodes, adapted to output the voltage value corresponding to the key interrupt value in response to the depression of the key. The key sensing apparatus may further comprise a plurality of bit lines, each respectively coupled to a different line electrode of the plurality of line electrodes aside from the first line electrode, adapted to perform bit operations. The key sensing apparatus may further comprise a first voltage-impression pull-up resistor adapted to provide a resistance corresponding to the key interrupt value, and a plurality of second voltage-impression pull-up resistors adapted to provide resistances corresponding to the voltage value. The first voltage-impression pull-up resistor may be connected in parallel to the key interrupt line. The plurality of second voltage-impression pull-up resistors may be connected in parallel to a corresponding bit line of the plurality of bit lines. The key bit detection unit may receive the voltage value from the plurality of second voltage-impression pull-up resistors in response to the depression of the key.

In another embodiment, a key adapted for use in a mobile station comprises an external electrode adapted to optionally provide an electrical ground, and a plurality of line electrodes disposed interior to the external electrode, optionally electrically disconnected from the external electrode. The key also comprises a dome sheet disposed in proximity to the external electrode and the plurality of line electrodes, adapted to provide an electrical connection between the external electrode and the plurality of line electrodes in response to depression of the key.

In yet another embodiment, a method for key sensing in a mobile station having a keypad comprising a plurality of keys comprises receiving a key interrupt value from the keypad in response to depression of a key, and receiving a voltage value from the keypad in response to output of the key interrupt value by the keypad. The method also comprises comparing the voltage value against stored key values, and identifying a depressed key based on the comparing of the voltage value against the stored key values. The voltage value may be a binary value having a set bit length. The stored key values may be stored in a key value table.

The present invention may provide more efficient key sensing and enable increased functionality in a mobile station by reducing the required number of general purpose input/output (GPIO) pins.

Although the present invention is described with reference to mobile stations, the preferred embodiments may also be used in any portable electronic devices.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A key sensing apparatus in a mobile station, the key sensing apparatus comprising:
a keypad comprising a plurality of keys;
a key interrupt block operatively coupled to the keypad, adapted to receive a key interrupt value from the keypad;
a key bit detection unit operatively coupled to the keypad, adapted to receive a voltage value from the keypad; and
a processing unit operatively coupled to the key interrupt block and the key bit detection unit, adapted to sense the voltage value in response to receipt of the key interrupt value by the key interrupt block.

2. The key sensing apparatus of claim 1, further comprising:
a key value table adapted to store key values, wherein the processing unit is adapted to compare the voltage value against stored key values in the key value table to identify a depressed key of the plurality of keys in the keypad.

3. The key sensing apparatus of claim 1, wherein the voltage value is a binary value having a set bit length.

4. The key sensing apparatus of claim 1, wherein a key of the plurality of keys in the keypad comprises:
an external electrode adapted to optionally provide an electrical ground;
a plurality of line electrodes disposed interior to the external electrode, optionally electrically disconnected from the external electrode; and
a dome sheet disposed in proximity to the external electrode and the plurality of line electrodes, adapted to provide an electrical connection between the external electrode and the plurality of line electrodes in response to depression of the key.

5. The key sensing apparatus of claim 4, further comprising a key interrupt line operatively coupled to a first line electrode of the plurality of line electrodes, adapted to output the voltage value corresponding to the key interrupt value in response to the depression of the key.

6. The key sensing apparatus of claim 5, further comprising:
a plurality of bit lines, each respectively coupled to a different line electrode of the plurality of line electrodes aside from the first line electrode, adapted to perform bit operations.

7. The key sensing apparatus of claim 6, further comprising:
a first voltage-impression pull-up resistor adapted to provide a resistance corresponding to the key interrupt value; and
a plurality of second voltage-impression pull-up resistors adapted to provide resistances corresponding to the voltage value.

8. The key sensing apparatus of claim 7, wherein the first voltage-impression pull-up resistor is connected in parallel to the key interrupt line.

9. The key sensing apparatus of claim 8, wherein the plurality of second voltage-impression pull-up resistors is connected in parallel to a corresponding bit line of the plurality of bit lines.

10. The key sensing apparatus of claim 9, wherein the key bit detection unit receives the voltage value from the plurality of second voltage-impression pull-up resistors in response to the depression of the key.

11. A key adapted for use in a mobile station, the key comprising:
an external electrode adapted to optionally provide an electrical ground;
a plurality of line electrodes disposed interior to the external electrode, optionally electrically disconnected from the external electrode; and
a dome sheet disposed in proximity to the external electrode and the plurality of line electrodes, adapted to provide an electrical connection between the external electrode and the plurality of line electrodes in response to depression of the key.

12. The key of claim 11, further comprising a key interrupt line operatively coupled to a first line electrode of the plurality of line electrodes, adapted to output a voltage value corresponding to a key interrupt value in response to the depression of the key.

13. The key of claim 12, further comprising:
a plurality of bit lines, each respectively coupled to a different line electrode of the plurality of line electrodes aside from the first line electrode, adapted to perform bit operations.

14. The key of claim 13, further comprising
a first voltage-impression pull-up resistor adapted to provide a resistance corresponding to the key interrupt value; and
a plurality of second voltage-impression pull-up resistors adapted to provide resistances corresponding to the voltage value.

15. The key of claim 14, wherein the first voltage-impression pull-up resistor is connected in parallel to the key interrupt line.

16. The key of claim 15, wherein the plurality of second voltage-impression pull-up resistors is connected in parallel to a corresponding bit line of the plurality of bit lines.

17. The key of claim 16, wherein the voltage value is a binary value having a set bit length.

18. A method for key sensing in a mobile station having a keypad comprising a plurality of keys, the method comprising:
receiving a key interrupt value from the keypad in response to depression of a key;
receiving a voltage value from the keypad in response to output of the key interrupt value by the keypad;
comparing the voltage value against stored key values; and
identifying a depressed key based on the comparing of the voltage value against the stored key values.

19. The method of claim 18, wherein the voltage value is a binary value having a set bit length.

20. The method of claim 18, wherein the stored key values are stored in a key value table.
